(19) United States
(12) Patent Application Publication
(10) Pub. No.: US 2013/0027302 A1
(43) Pub. Date: Jan. 31, 2013

(54) ELECTRONIC DEVICE, ELECTRONIC DOCUMENT CONTROL PROGRAM, AND ELECTRONIC DOCUMENT CONTROL METHOD

(71) Applicants: Tomoki IWAIZUMI, Osaka (JP); Seiji YAMADA, Osaka (JP)

(72) Inventors: Tomoki IWAIZUMI, Osaka (JP); Seiji YAMADA, Osaka (JP)

(73) Assignee: KYOCERA CORPORATION, Kyoto (JP)

(21) Appl. No.: 13/558,216

(22) Filed: Jul. 25, 2012

(30) Foreign Application Priority Data
Jul. 25, 2011 (JP) 2011-161504

(51) Int. Cl. G06F 3/033

(52) U.S. Cl. 345/158

(57) ABSTRACT

There are provided an electronic device, an electronic document control program and an electronic document control method for the electronic device. The electronic device includes a display unit configured to display an electronic document, an image taking unit configured to take an image, an eye-gaze position detecting unit configured to detect an eye-gaze position with respect to the display unit based on the image taken by the image taking unit, a determining unit configured to determine whether the electronic document displayed on the display unit has been read based on the eye-gaze position detected by the eye-gaze position detecting unit, and a performing unit configured to perform a predetermined process on the electronic document if the determining unit determines that the electronic document has been read.

### CROSS-REFERENCE TO RELATED APPLICATION

This application claims priority from Japanese Patent Application No. 2011-161504, filed on Jul. 25, 2011, the entire subject matter of which is incorporated herein by reference.

### BACKGROUND OF THE INVENTION

1. Field of the Invention

The present invention relates to an electronic device, an electronic document control program, and an electronic document control method, and more particularly, to an electronic device, an electronic document control program, and an electronic document control method for displaying electronic documents.

2. Description of the Related Art

JP 2007-102360 A discloses an electronic book device which is an example of an electronic device for displaying electronic documents. The electronic book device can detect an eye gaze of a user, thereby determining an attention position on a display unit. When an image based on book data is displayed on the display unit, an attention portion of the book data displayed at the attention portion is specified, and the contents represented by the attention portion are displayed with highlight.

### SUMMARY OF THE INVENTION

However, the electronic book device of JP 2007-102360 A cannot determine whether the user understands the contents of the book data.

Accordingly, an aspect of the present invention provides a novel electronic device, an electronic document control program, and an electronic document control method.

Another aspect of the present invention provides an electronic device, an electronic document control program, and an electronic document control method allowing a user to understand the contents of electronic documents.

According to an illustrative embodiment of the present invention, there is provided an electronic device comprising a display unit configured to display an electronic document, an image taking unit configured to take an image, an eye-gaze position detecting unit configured to detect an eye-gaze position with respect to the display unit based on the image taken by the image taking unit, a determining unit configured to determine whether the electronic document displayed on the display unit has been read based on the eye-gaze position detected by the eye-gaze position detecting unit, and a performing unit configured to perform a predetermined process on the electronic document if the determining unit determines that the electronic document has been read.

According to the above configuration, only by browsing an electronic document, it is possible to make progress in viewing the electronic document without performing complicated operation.

The above electronic device may further comprise an eye-gaze speed calculating unit configured to calculate an eye-gaze moving speed based on the eye-gaze position detected by the eye-gaze position detecting unit. If the eye-gaze speed calculated by the eye-gaze speed calculating unit is equal to or smaller than a first threshold value, the determining unit may determine that the electronic document displayed on the display unit has been read.

According to this configuration, the eye-gaze speed based on the eye-gaze position can be used to determine whether the contents of the electronic document have been read.

In the above electronic device, the electronic document may include a detection area for displaying a text or an image, and the electronic device may further comprise a staying-time measuring unit configured to measure a staying time of the eye-gaze position detected by the eye-gaze position detecting unit within the detection area. If the staying time measured by the staying-time measuring unit is equal to or longer than a second threshold value, the determining unit may determine that the electronic document displayed on the display unit has been read.

According to this configuration, it is possible to use the staying time based on the eye-gaze position to determine whether the contents of the electronic document have been read.

In the above electronic device, the electronic document may include a detection area for displaying a text or an image, and the electronic device may further comprise an eye-gaze speed calculating unit configured to calculate an eye-gaze moving speed based on the eye-gaze position detected by the eye-gaze position detecting unit, and a staying-time measuring unit configured to measures a staying time of the eye-gaze position detected by the eye-gaze position detecting unit within the detection area. If the eye-gaze speed calculated by the eye-gaze speed calculating unit is equal to or smaller than a first threshold value and if the staying time measured by the staying-time measuring unit is equal to longer than a second threshold value, the determining unit may determine that the electronic document displayed on the display unit has been read.

According to this configuration, it is possible to use the eye-gaze speed and the staying time based on the eye-gaze position to determine whether the contents of the electronic document have been read.

The above electronic device may further comprise a termination operation determining unit configured to determine whether a termination operation is performed, and a storing unit configured to store stop data based on the eye-gaze position detected by the eye-gaze position detecting unit if the termination operation determining unit determines that the termination operation is performed.

According to this configuration, even if the user stops browsing the electronic document, it is possible to easily restart browsing the electronic document by using the stop data is used.

In the above electronic device, the electronic document may include a plurality of pages, and the performing unit may include a next-page display unit configured to display a next page if the determining unit determines that one page of the electronic document has been read.

According to this configuration, only by making progress in viewing the electronic document, it is possible to cause the electronic device to display the next page.

In the above electronic device, the performing unit may include a key display unit configured to display a key for inputting agreement or disagreement to contents of the electronic document to be operable if the determining unit determines that the electronic document has been read.

According to this configuration, it is possible to prevent the user from agreeing with the contents of the electronic document, without understanding of the contents or by erroneous operation.

In the above electronic device, the performing unit may include a first additional information display unit configured to display additional information in the detection area if the determining unit determines that the detection area of the electronic document has been read.

According to this configuration, after it is determined that a portion of the electronic document has been read, the additional information is displayed. Therefore, it is possible to support in making progress in viewing the electronic document.

In the above electronic device, the performing unit may include a second additional information display unit configured to display additional information in another detection area different from the detection area which displays an image if the determining unit determines that the detection area displaying the texts has been read.

According to this configuration, it is possible to surprise the user viewing the electronic document with a visible change.

According to another illustrative embodiment of the present invention, there is provided a computer-readable storage medium having an electronic document control program stored thereon and readable by a processor of an electronic device which includes a display unit configured to display an electronic document and an image taking unit configured to take an image, the program, when executed by the processor, causing the processor to perform operations comprising: detecting an eye-gaze position with respect to the display unit based on the image taken by the image taking unit; determining whether the electronic document displayed on the display unit has been read based on the detected eye-gaze position; and performing a predetermined process on the electronic document if it is determined that the electronic document has been read.

According to this configuration, only by browsing the electronic document, it is possible to make progress in viewing the electronic document without performing complicated operation.

According to a further illustrative embodiment of the present invention, there is provided an electronic document control method for an electronic device including a display unit configured to display an electronic document and an image taking unit configured to take an image, the method comprising: detecting an eye-gaze position with respect to the display unit based on the image taken by the image taking unit; determining whether the electronic document displayed on the display unit has been read based on the detected eye-gaze position; and performing a predetermined process on the electronic document if it is determined that the electronic document has been read.

According to this configuration, only by browsing the electronic document, it is possible to make progress in viewing the electronic document without performing complicated operation.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a view illustrating an electric configuration of an electronic document terminal according to an illustrative embodiment of the present invention;

FIG. 2 is a view illustrating an example of an outer appearance of the electronic document terminal shown in FIG. 1;

FIGS. 3A and 3B are views illustrating an example of an eye-gaze position detected by the electronic document terminal shown in FIG. 2;

FIGS. 4A to 4D are views illustrating an example of a change in the eye-gaze position detected by the electronic document terminal shown in FIG. 1;

FIGS. 5A to 5D are views illustrating another example of a change in the eye-gaze position detected by the electronic document terminal shown in FIG. 1;

FIG. 6 is a view illustrating an example of an electronic document displayed on a display shown in FIG. 1;

FIGS. 7A and 7B are views illustrating an example of the configuration of the electronic document shown in FIG. 6;

FIGS. 8A and 8B are views illustrating an example of a change in the eye-gaze position detected from the electronic document shown in FIG. 6;

FIG. 9 is a view illustrating another example of the configuration of the electronic document shown in FIG. 6;

FIG. 10 is a view illustrating an example of a state table stored in a RAM shown in FIG. 1;

FIGS. 11A and 11B are views illustrating another example of the electronic document displayed on the display shown in FIG. 2;

FIGS. 12A and 12B are views illustrating another example of the electronic document displayed on the display shown in FIG. 2;

FIGS. 13A and 13B are views illustrating another example of the electronic document displayed on the display shown in FIG. 2;

FIG. 14 is a view illustrating an example of a memory map of the RAM shown in FIG. 1;

FIG. 15 is a flow chart illustrating an example of an electronic document control process of a processor shown in FIG. 1;

FIG. 16 is a flow chart illustrating an example of a text display process of the processor shown in FIG. 1;

FIG. 17 is a flow chart illustrating an example of a text/image display process of the processor shown in FIG. 1;

FIG. 18 is a flow chart illustrating an example of an image display process of the processor shown in FIG. 1; and

FIG. 19 is a flow chart illustrating an example of the eye-gaze position detecting process of the processor shown in FIG. 1.

### DETAILED DESCRIPTION OF THE INVENTION

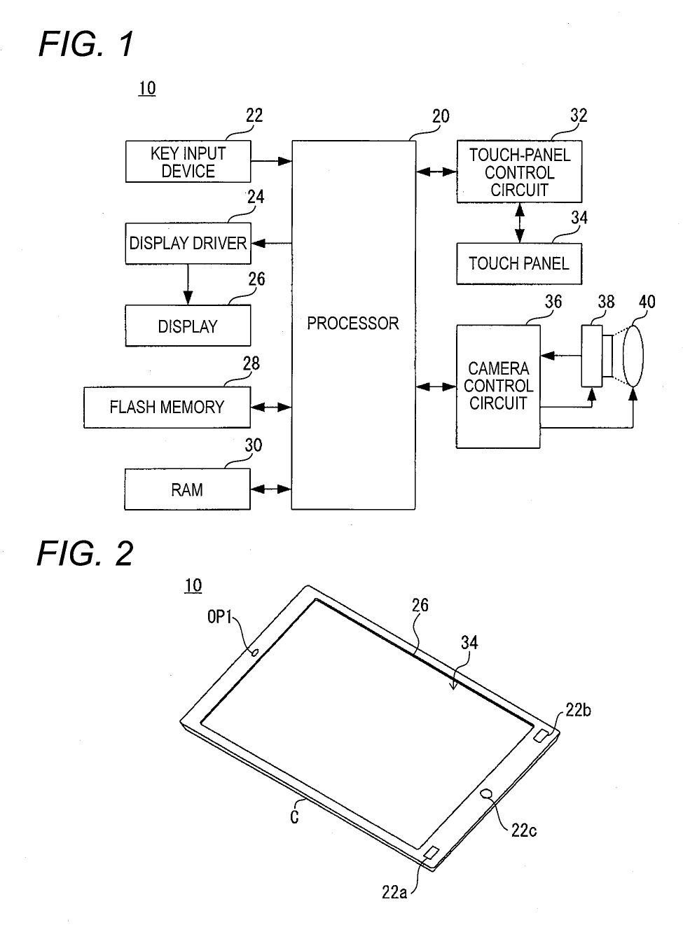

Referring to FIG. 1, an electronic document terminal (also referred to as an electronic book terminal or an electronic book reader) 10 of the present illustrative embodiment is an electronic device or portable device, and displays ‘electronic documents’ such as novels, comics, and picture books to be viewable. Also, the electronic document terminal 10 performs processes such as a process of turning pages of a displayed electronic document in response to user's operation. In the present illustrative embodiment, the ‘electronic document’ includes not only books such as novels, comics, picture books, photo books, and instruction manuals but also magazines, news papers, contracts, and the like.

The electronic document terminal 10 includes a processor 20 which is referred to as a computer or a CPU. The processor 20 is connected to a key input device 22, a display driver 24, a flash memory 28, a RAM 30, a touch-panel control circuit 32, and a camera control circuit 36. The display driver 24 is also connected to a display 26 (an example of a display unit). Further, the touch-panel control circuit 32 is connected to a touch panel 34. Furthermore, the camera control circuit 36 is connected to an image sensor 38 and a control motor (not shown) for controlling the lens position of a focus lens 40.

The processor 20 takes charge of overall control on the electronic document terminal 10. The RAM 30 is used as a buffer area or a work area (including a drawing area) of the processor 20. The flash memory 28 records the data of the contents of the electronic document terminal 10, such as letters, images, and electronic documents.

The key input device 22 includes operation keys, function keys, and the like. Information (key data) on keys operated by the user is input to the processor 20. If a key of the key input device 22 is operated, a click sound is generated. Therefore, by hearing the click, the user can have an operational feeling for the key operation.

Under the instruction of the processor 20, the display driver 24 controls display of the display 26 connected to the display driver 24. Also, the display driver 24 includes a video memory (not shown) for temporarily storing image data to be displayed. Although not shown, the display 26 is irradiated by a backlight.

The touch panel 34 detects the contact of the touch panel 34, for example, with one or more fingers by an electrostatic capacitance method which detects a change in electrostatic capacitance between electrodes occurring when an object such as a finger comes closer to a surface. Also, the touch panel 34 is provided on the display 26, and is a pointing device for indicating an arbitrary position in the screen of the touch panel. The touch-panel control circuit 32 detects touch operation such as pressing, stroking, and touching in a touch sensing area of the touch panel 34, and outputs data of coordinates indicating the position of the touch operation to the processor 20. In other words, the user can input operation directions, figures, or the like by pressing, stroking, or touching the surface of the touch panel 34 with fingers.

Here, user's operation of touching an upper surface of the touch panel 34 with a finger is referred to as ‘touch’. Meanwhile, operation of separating a finger from the touch panel 34 is referred to as ‘release’. Also, user's operation of touching the upper surface of the touch panel 34 and performing release is referred to as ‘touch and release’.

Further, operation of stroking the surface of the touch panel 34 is referred to as ‘slide’, and operation of sequentially performing touch, slide, and release is referred to as ‘touch slide’. Furthermore, operation of successively performing touch and release two times is referred to as ‘double tap’, and operation of almost simultaneously touching two places is referred to as ‘multi-touch’. That is, the ‘touch operation’ includes touch, release, touch and release, slide, touch slide, double tap, and multi-touch described above, and the like.

A coordinate indicated by touch is referred to as a ‘touch point’ (touch start position), and a coordinate indicated by release is referred to as a ‘release point’ (touch end position).

The touch operation may be performed by not only fingers but also a touch pen having an electric conductor at its tip end, and the like. Also, the detection method of the touch panel 34 may be a surface type electrostatic capacitance method, a resistive film method, an ultrasonic wave method, an infrared method, an electromagnetic induction method, or the like.

The camera control circuit 36, the image sensor 38, the focus lens 40, and the like may be referred to collectively as a camera module or an image taking unit. The camera control circuit 36 is a circuit for outputting still images or moving images at the electronic document terminal 10. In an image taking area of the image sensor 38, light receiving elements corresponding to SXGA (1280×1026 pixels) are disposed. Therefore, if an optical image of a photographic object is irradiated onto the image sensor 38, in the image taking area, electric charge corresponding to the optical image of the photographic object, that is, a raw image signal of SXGA is generated by photoelectric conversion. The user can set the image size of image data (the number of pixels) not only to SXGA but also to XGA (1024×768 pixels), VGA (640×480 pixels), or the like.

For example, if a camera function is performed, the processor 20 activates an image sensor driver built in the camera control circuit 36, and instructs the image sensor driver to perform an exposing operation and an electric-charge reading operation corresponding to a designated read area.

The image sensor driver exposes an imaging surface of the image sensor 38, and reads electric charge generated by the exposure. As a result, a raw image signal is output from the image sensor 38. The output raw image signal is input to the camera control circuit 36, and the camera control circuit 36 performs processes, such as color separation, white balance adjustment, and YUV conversion, on the input raw image signal, so as to generate YUV image data. The YUV image data is input to the processor 20.

The processor 20 stores (temporarily stores) the input YUV image data in the RAM 30. Here, when the camera function is performed to detect the eye-gaze position of the user, the eye-gaze position is detected based on the YUV image data stored in the RAM 30. Since the detection of the eye-gaze position will be described below, it is not described here in detail. Here, the eye-gaze position refers to a position of a display area of the display 26, to which the user pays attention.

The camera control circuit 36 calculates a focus average value from the raw image signal, and outputs the focus average value to the processor 20. The processor 20 performs an auto-focus (AF) process based on the focus average value output from the camera control circuit 36. If the AF process is performed, under the instruction of the processor 20, the camera control circuit 36 controls a lens motor such that the lens position of the focus lens 40 is adjusted. As a result, an image with the photographic object in focus is taken.

When an option for displaying taken images on the display 26 is set, the stored YUV image data is converted into RGB image data by the processor 20, and the RGB image data is transmitted from the RAM 30 to the display driver 24. Then, the RGB image data is output to the display 26. Therefore, a through-the-lens image of a low resolution (for example, 320×240 pixels) showing the photographic object is displayed on the display 26.

FIG. 2 is a view illustrating the outer appearance of the electronic document terminal 10. Referring to FIG. 2, the electronic document terminal 10 includes a housing C which is rectangular in a plan view. The key input device 22 includes a first operation key 22a, a second operation key 22b, and a function key 22c. These keys are provided at a surface of the housing C. The display 26 is attached such that a display surface (monitor surface) is seen from the surface of the housing C. On the display surface of the display 26, the touch panel 34 is also provided.

For example, the user operates the function key 22c such that a list of electronic document files is displayed, and performs touch operation to select an arbitrary electronic document file. Also, if an electronic document is displayed, the user can use the first operation key 22a and the second operation key 22b to turn (change) the pages of the electronic document. For example, if the first operation key 22a is operated, the previous page is displayed, and if the second operation key 22b is operated, the next page is displayed.

An opening OP1 is connected to the focus lens 40 and the image sensor 38. In other words, the camera module (not shown) is built in the housing C, and an object field at the surface side of the housing C is imaged through the opening OP1. The opening OP1 is provided on one side of the surface of the housing C in the longitudinal direction such that it is possible to take an image of the face of the user.

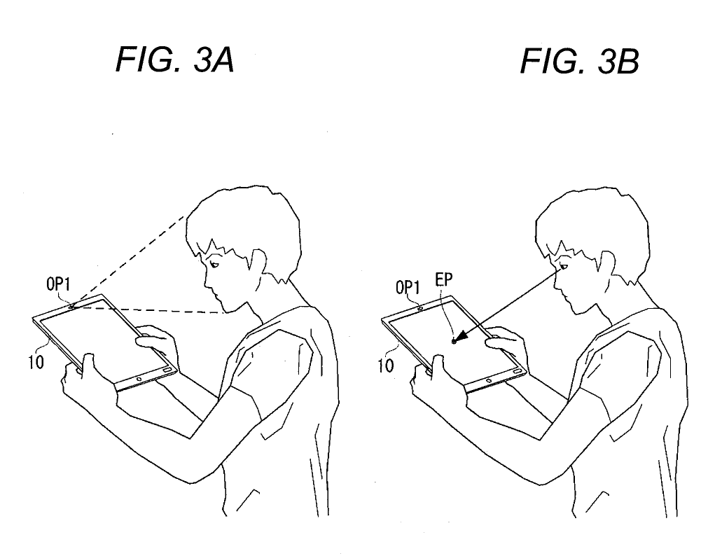

Here, in a case of detecting the eye-gaze position of the user, the eye-gaze position is detected based on the image of the user's face taken in a state as shown in FIG. 3A. Specifically, the processor 20 determines whether the image (taken image) output from the camera module includes a face area. In a case where the taken image includes a face area, eye areas are extracted. If the eye areas are extracted, a predetermined image process is performed such that the centers of iris areas are calculated, whereby the eye-gaze direction of the user is estimated. Next, as shown in FIG. 3B, the eye-gaze position EP is detected based on the eye-gaze direction, and the eye-gaze distance between the face of the user and the display 26.

The eye-gaze distance may be set to a value obtained through experiments or the like, in advance, or may be estimated from the size of the user's face in the taken image, or the like. In a case of providing a distance measuring sensor using an infrared ray or the like, the measuring sensor may be used to obtain the eye-gaze distance.

Since the processor 20, the display driver 24, the flash memory 28, the RAM 30, the touch-panel control circuit 32, the camera control circuit 36, the image sensor 38, and the focus lens 40 are built in the housing C, they are not shown in FIGS. 2, 3A, and 3B.

Next, in the present illustrative embodiment, based on the detected eye-gaze position, the moving speed of the eye gaze (the eye-gaze speed) ES and a time (staying time) ET during which the eye gaze stays at a detection area DA of pictures, texts, and the like in the electronic document are calculated. Hereinafter, assuming that a certain time is T and a time interval (frame time) at which the display of the display 26 is updated is Δt, the eye-gaze speed ES and the staying time ET will be described.

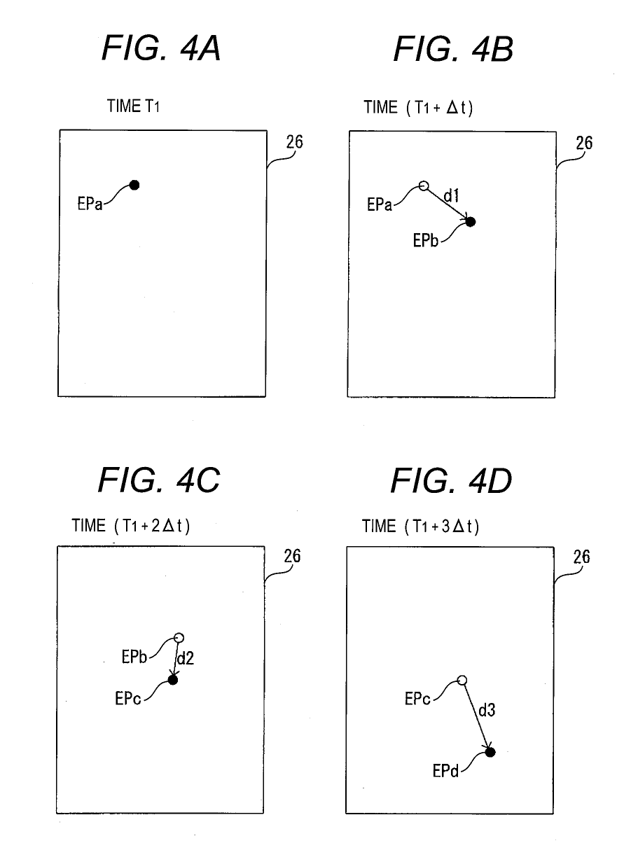

First, the eye-gaze speed ES will be described. FIGS. 4A to 4D show changes of the eye-gaze position EP in the display area of the display 26 at intervals of Δt ms from a certain time T₁. For example, when Δt ms elapses from the time T₁, the eye gaze moves from a position EPa to a position EPb, and the distance between the two positions (an amount of change) becomes d1 mm. Also, when 2Δt ms elapses from the time T₁, the eye-gaze position EP moves from the position EPb to a position EPc, and an amount of change becomes d2 mm. Further, when 3Δt ms elapses from the time T₁, the eye-gaze position EP moves from the position EPc to a position EPd, and an amount of change becomes d3 mm.

In the present illustrative embodiment, based on the frame time Δt (ms) and each amount of change d (mm), an instant speed sₘ (mm/ms) is calculated for every frame, and an average of instant speeds sₘ (mm/ms) for a predetermined time period (for example, 3Δt (ms)) is calculated as the eye-gaze speed ES. Therefore, the eye-gaze speed ES is calculated (updated) every predetermined time period.

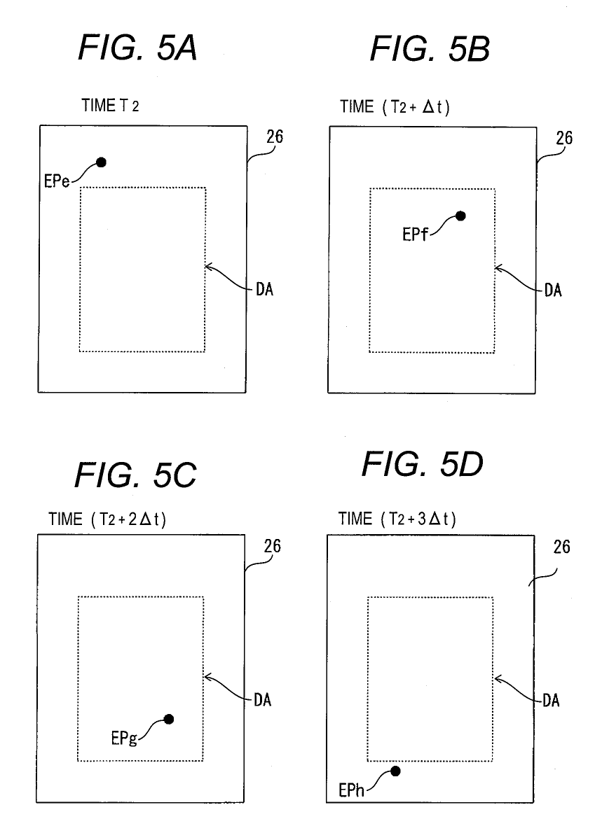

Subsequently, the staying time T will be described. FIGS. 5A to 5D show changes of the eye-gaze position EP in the display area of the display 26 at intervals of Δt ms from a certain time T₂. Although any texts and images are not shown, the detection area DA is provided in the display area. For example, at the time T₂, the eye gaze of the user is at a position EPe outside the detection area DA. However, at a time (T₂+Δt), the eye gaze of the user is at a position EPf inside the detection area DA. Also, at a time (T₂+2Δt), the eye gaze of the user is at a position EPg inside the detection area DA. However, at a time (T₂+3Δt), the eye gaze of the user is at a position EPh outside the detection area DA. In other words, in a period from the time T₂ to the time (T₂+3Δt), since the eye-gaze position EP is included in the detection area DA from the time (T₂+Δt) to the time (T₂+3Δt), the staying time ET of the eye-gaze position EP in the detection area DA becomes 2Δt (ms). According to a specific measuring method, it is determined whether the eye-gaze position EP is included in the detection area DA for every frame update, and the number of times it is successively determined that the eye-gaze position EP is included in the detection area DA is counted. The product of the counted number of times and the frame time Δt becomes the staying time ET.

The methods of calculating and measuring the eye-gaze speed ES and the staying time ET are not limited to the methods described above. In other illustrative embodiments, other methods may be used to obtain the eye-gaze speed ES and the staying time ET.

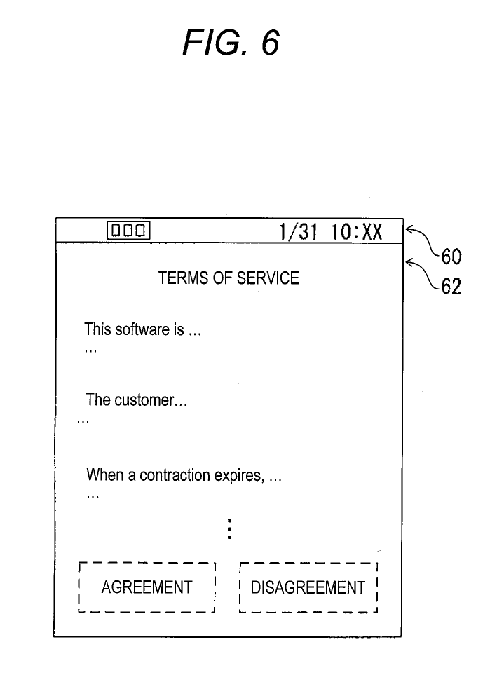

FIG. 6 is a view illustrating an example of the display 26 displaying an electronic document. The display of the display 26 includes a state display area 60 for displaying icons representing date and time, a remaining battery level, and the like, and a function display area 62 for displaying an electronic document. When the user performs operation to browse an electronic document file of a contract, metadata (to be described below) is read, and the contract is displayed in the function display area 62 as shown in FIG. 6.

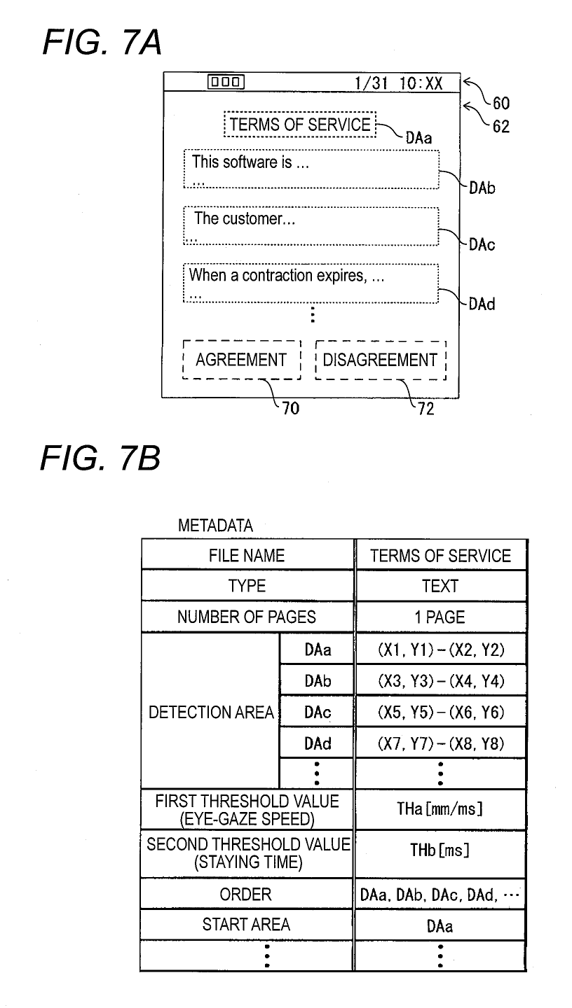

Referring to FIG. 7A, the electronic document (contract) includes a detection area DAa including a title text, detection areas DAb to DAd including texts representing the contents, an agreement key 70 for input agreement to the contents of the contract, and a disagreement key 72 for inputting disagreement to the contents of the contract. In an initial state, operation on the agreement key 70 and the disagreement key 72 is invalid. In order to display this state, the two keys are surrounded by dotted line frames, and letters are displayed in italic font style.

The metadata of a file of an electronic document includes the name of the electronic document file, the type of the electronic document, the number of pages of the electronic document, coordinate ranges of detection areas DA, and a first threshold value, a second threshold value, an order, a start area, and the like for determining whether to perform a predetermined process to be described below.

For example, referring to FIG. 7B, in the metadata of the file of the contract (electronic document), ‘TERMS OF SERVICE’ is recorded in the item ‘FILE NAME’, ‘TEXT’ representing that the electronic document is composed mainly of texts is recorded in the item ‘TYPE’, and the coordinate ranges of the detection areas DAa to DAd and others are recorded in the item ‘DETECTION AREA’. Further, ‘1 PAGE’ is recorded as the total number of pages of the contract in the item ‘NUMBER OF PAGES’.

Furthermore, in the metadata, a threshold value THa (mm/ms) is recorded in the item ‘FIRST THRESHOLD VALUE’ for the eye-gaze speed, and a threshold value THb (ms) is recorded in the item ‘SECOND THRESHOLD VALUE’ for the staying time. Moreover, in the item ‘ORDER’, ‘DAa, DAb, DAc, DAd, . . . ’ is recorded as the order of browsing the detection areas DA, and in the item ‘START AREA’, ‘DAa’ is recorded as a position to start control based on the eye-gaze position EP.

Here, in the present illustrative embodiment, it is determined whether the eye-gaze speed ES and the staying time ET based on the eye-gaze position EP of the user satisfy conditions based on the first threshold value and the second threshold value in all detection areas DA. If the conditions are satisfied, it is determined that the contents of the detection areas DA have been read by the user, and a predetermined process is performed according to the type of the electronic document.

Specifically, first, the processor 20 reads the metadata of the electronic document. If the first threshold value and the second threshold value are recorded, it is determined that it is necessary to perform the predetermined process based on the eye gaze.

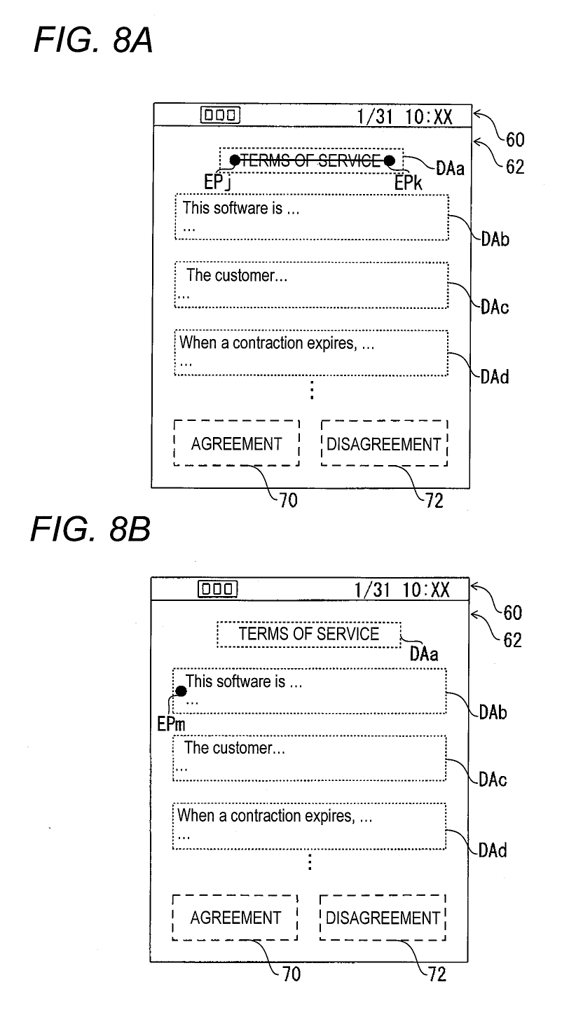

Referring to FIG. 8A, when it is determined that the predetermined process is necessary, if the user directs the eye gaze to the detection area DAa and the eye-gaze position is detected at a position EPj inside the detection area DAa, it is determined whether the detection area DAa is the start area of the electronic document. Here, since the detection area DAa including the position EPj of the eye gaze is the start area, the type ‘TEXT’ is read from the metadata and a text display process is performed according to ‘TEXT’.

If the text display process is performed, it is determined whether the eye-gaze speed ES is equal to or smaller than the first threshold value THa, and the staying time ET of the eye-gaze position EP at the detection area DAa is equal to or longer than the second threshold value THb. In this state, if the user moves the eye gaze from the position EPj to a position EPk and thus the above-mentioned conditions are satisfied, it is determined that the contents of the detection area DAa have been read. Next, as shown in FIG. 8B, a read completion process of changing letters included in the detection area DAa to the italic font style and reducing the size of the letters is performed.

As described above, in the present illustrative embodiment, it is possible to use the staying time ET at the detection area DA displaying letters, and the eye-gaze speed ES based on the eye-gaze position EP to determine whether the contents of the electronic document have been read.

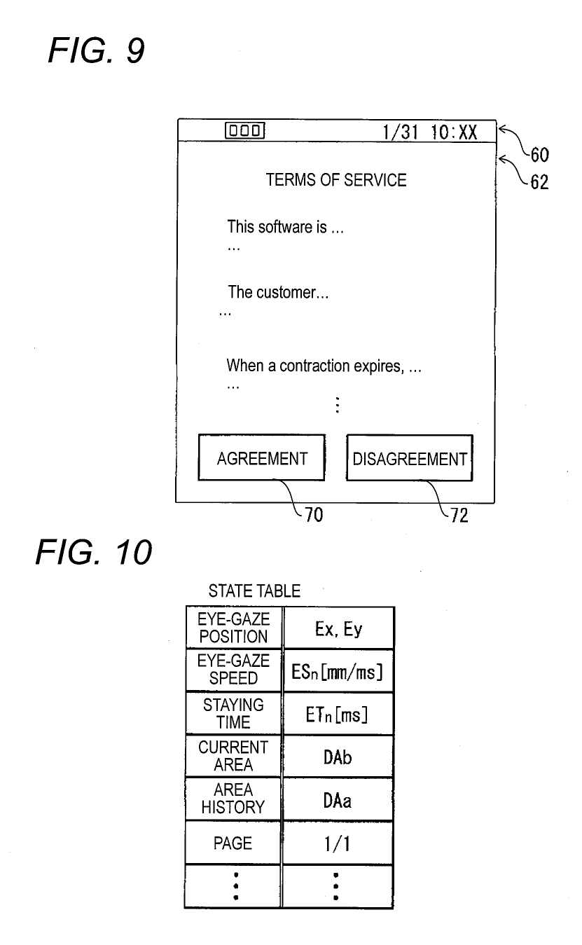

Further, for the other detection areas DA, the processor 20 determines whether the eye-gaze speed ES and the staying time ET satisfy the conditions based on the first threshold value THa and the second threshold value THb. If it is determined that the user has read the contents of all of the detection areas DA, a read finishing process is performed as the predetermined process such that the agreement key 70 and the disagreement key 72 are displayed to be selectable as shown in FIG. 9. That is, since it can be determined that all of the contents of the contract displayed as the electronic document have been completely read by the user, the agreement key 70 and the disagreement key 72 become selectable such that it is possible to agree or disagree with the contents of the contract. These keys may be operated by touch operation on the touch panel 34, or by the first operation key 22a and the second operation key 22b.

As described above, in the present illustrative embodiment, when a contract is displayed as an electronic document to be viewable, it is possible to enable the user to agree or disagree with the contents after making the user read through the contents. Therefore, it is possible to prevent the user from agreeing with the contents of the contract, without understanding the contents or by erroneous operation.

In a case of detecting the eye-gaze position EP, the detection result is recorded in a state table shown in FIG. 10. Referring to FIG. 10, in the state table, the coordinates of the detected current eye-gaze position EP, a calculated current eye-gaze speed, a calculated current staying time, a detection area including the current eye-gaze position EP, a history of detection areas DA determined as they have been read, and the number of currently displayed page are recorded. For example, when the user moves the eye-gaze position EP to a position EPm inside the detection area DAb as shown in FIG. 8B, in the state table, coordinates (Ex, Ey) are recorded as the eye-gaze position EP, ESₙ (mm/ms) is recorded as the eye-gaze speed ES, ETₙ (ms) is recorded as the staying time, DAb is recorded as the current area, DAa is recorded as the area history, and 1/1 representing that the first page of total 1 page is being browsed is recorded in the page item.

When the user performs termination operation of pressing the function key 22c for a long time during browsing of the electronic document, the current area, the area history, the page, and the like recorded in the state table are stored as stop data. That is, even if the user stops browsing the electronic document, by using the stop data as a bookmark, it is possible to easily restart browsing the electronic document.

Even in cases of displaying electronic documents other than contracts, that is, novels composed mainly of texts like contracts, comics including texts and images in one detection area DA, picture books composed mainly of images, and the like, a predetermined process is performed based on the eye-gaze position EP.

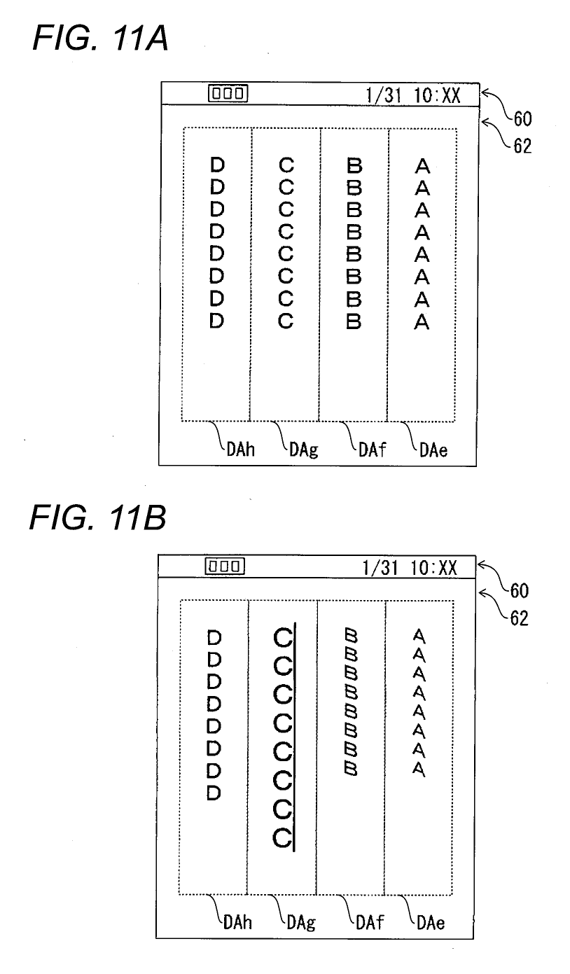

Referring to FIGS. 11A and 11B, in a case of displaying a novel having the type ‘TEXT’, for example, a detection area DA is set for each sentence. For example, a detection area DAe includes a sentence ‘AAA . . . ’, a detection area DAf includes a sentence ‘BBB . . . ’, a detection area DAg includes a sentence ‘CCC . . . ’, and a detection area DAh includes a sentence ‘DDD . . . ’.

In an initial state shown in FIG. 11A, letters included in each detection area DA are displayed in the same font style. However, if the user reads the novel, since the read completion process is performed, letters in a detection area DA determined as it has been read are changed to the italic font style, and the size of the letters is reduced, as shown in FIG. 11B. Further, letters of a detection area DA including the eye-gaze position EP are ruled, and increase in size. Furthermore, letters of a detection area DA determined as it has not been yet read remains at the initial state.

Therefore, the user can intuitively recognize places which have been read, a place which is being reading, and places which have not been yet read. As a result, convenience during reading according to an electronic document is improved.

In a case where a plurality of pages are included in an electronic document like a novel, if it is determined that all of the contents of a displayed page has been read, a page changing process is performed as the predetermined process such that the next page is displayed. That is, by the user only reading the texts, it is possible to display the next page without any operation. However, since the user might reconfirm the previous page, the user can operate the first operation key 22a or the second operation key 22b such that the next page (or the previous page) is displayed.

Even in a case of displaying a novel as an electronic document, if a page is read through, the read finishing process is performed as the predetermined process. In the case where the electronic document is a novel, if the read finishing process is performed, that time is recorded as a reading log. Thereafter, if checking the reading log, the user can grasp a time passage in which the novel has been read. Therefore, the convenience of reading using electronic documents is further improved.

In a case of a novel, each detection area DA may include a sentence, a line, a paragraph, a section, a chapter, or the like. When the electronic document terminal 10 has a touch panel, the page changing process may be performed not only by operation on the first operation key 22a or the second operation key 22b but also by the touch operation.

If the read completion process is performed, not only the font style and size of letters but also the color of the letters may be changed.

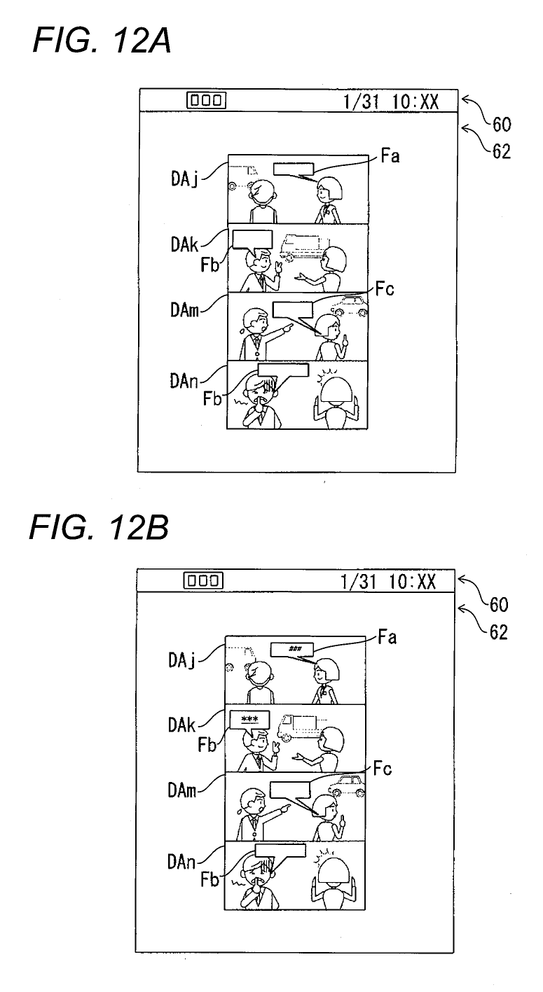

Referring to FIGS. 12A and 12B, in a case of displaying a comic as an electronic document having the type ‘TEXT/IMAGE’, frames of the comic correspond to detection areas DA. Each frame includes an image including person characters, a background, and the like, and balloons F having words of the characters written therein. In FIGS. 12A and 12B, a so-called four-frame comic composed of four frames is displayed on the display 26. A detection area DAj is the first frame and includes a balloon Fa of a woman character, a detection area DAk is the second frame and includes a balloon Fb of a man character, a detection area DAm is the third frame and includes a balloon Fc of the woman character, and a detection area DAn is the fourth frame and includes a balloon Fd of the man character. However, in an initial state shown in FIG. 12A, the balloon of each frame has no written words (sentences).

In this state, if the eye-gaze position EP of the user is included in the first frame (the detection area DAj), and the eye-gaze speed ES and the staying time ET satisfy the conditions based on the first threshold value and the second threshold value, a first additional information display process is performed as the predetermined process.

Specifically, if the first additional information display process is performed, words (‘###’) is displayed as additional information in the balloon Fa. Similarly, if it is determined that the second frame (the detection area DAk) has been read, words (‘***’) is displayed in the balloon Fb. In other words, if it is determined that a frame of the comic has been read, additional information is displayed in the frame to support reading the comic.

Also, referring to FIG. 12B, when the current eye-gaze position EP is included in the second frame (the detection area DAk), the words written in the balloon Fb is underlined. Meanwhile, the words written in the balloon Fa of the already read first frame (the detection area DAj) decrease in letter size, and is changed to the italic font style. In other words, even in the case of the comic, the read completion process is performed. Therefore, like a novel, the user can intuitively recognize frames which have been read, a frame which is being read, and frames which have not been yet read. As a result, convenience during reading comics is improved.

Also, similarly to the case of a novel, if it is determined that all of the frames (the detection areas DA) have been read, the next page is displayed. Further, in a case where the electronic document terminal 10 has a speaker, simultaneously with display of words in a balloon F, effects such as concentrated line may be added, colors may be added to a corresponding image, or sound effects may be output. Furthermore, in a case where the electronic document terminal 10 has a vibrator, simultaneously with display of words in a balloon F, the vibrator may vibrate.

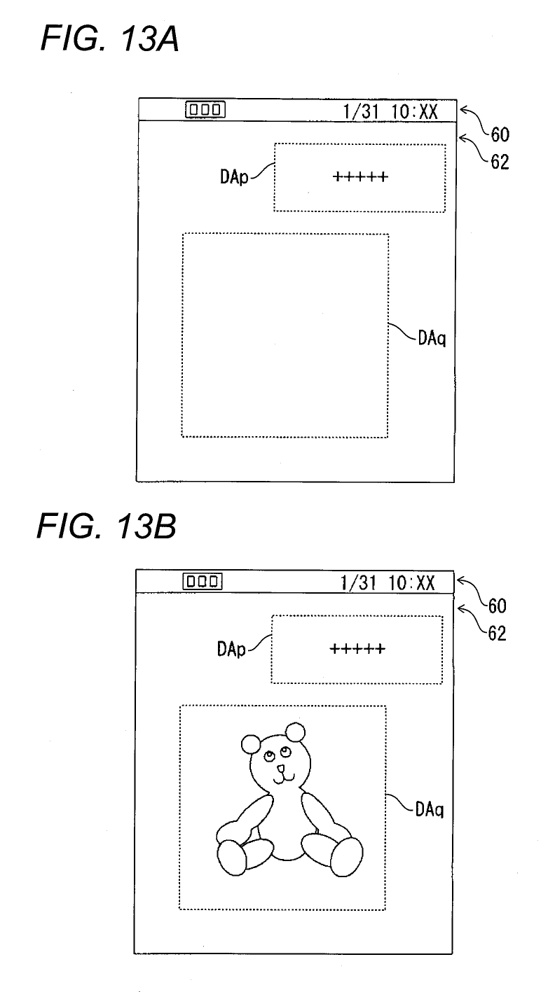

Referring to FIGS. 13A and 13B, in a case of displaying a picture book as an electronic document having the type ‘IMAGE’, in one page, a text and a picture (image) are displayed in different detection areas DA. However, in an initial state, in a detection area DAp, a letter string ‘+++’ is written, but in a detection area DAq, no image is not drawn.

In this state, if the staying time ET and the eye-gaze speed ES based on the eye-gaze position EP satisfy the conditions based on the first threshold value and the second threshold value, a second additional information display process is performed as the predetermined process. As a result, a picture (image) is displayed as additional information in the detection area DAq. Therefore, it is possible to surprise the user reading the picture book with a visible change.

If it is determined that the eye-gaze position EP has moved to the detection area DAq displaying the image, and the detection area DAq displaying the image has been watched (read), after a predetermined time elapses, the next page is displayed. The reason is that, if the next page is displayed immediately after it is determined that the detection area DAq displaying the picture (image) has been read, the user cannot slowly appreciate the picture (image). Therefore, in the present illustrative embodiment, after the predetermined time elapses, the next page is displayed such that the user can appreciate the displayed picture.

When the additional information such as an image is displayed, sound effects, music, and the like may be reproduced. Also, additional information to be displayed may be still images and moving images. In other illustrative embodiments, as soon as it is determined that a text (words) has been read, it may be determined that an associated image (picture) has also been read.

As described above, in the present illustrative embodiment, the user can read the electronic document only by browsing the electronic document without performing complicated operation.

Further, since the electronic document terminal 10 enables the user to browse an electronic document without using the touch panel, the visibility of the display 26 does not decrease due to touch operation. For example, in the related-art electronic document terminal having the touch panel provided to the display 26, since the page update process is performed by touch operation, the finger-print of a finger performing the touch operation or the like is attached as contamination to the touch panel. In this case, since the visibility of the display 26 decrease due to the contamination, in order to continuously browse the electronic document, the user should wipe away the contamination. However, in the electronic document terminal 10 of the present illustrative embodiment, since it is possible to easily update the page without performing touch operation, even if the user continuously browses the electronic document, the visibility of the display 26 does not decrease.

Further, since it is possible to read the electronic document without using hands, even if the user cannot use hands freely, the user can use the electronic document terminal 10 of the present illustrative embodiment.

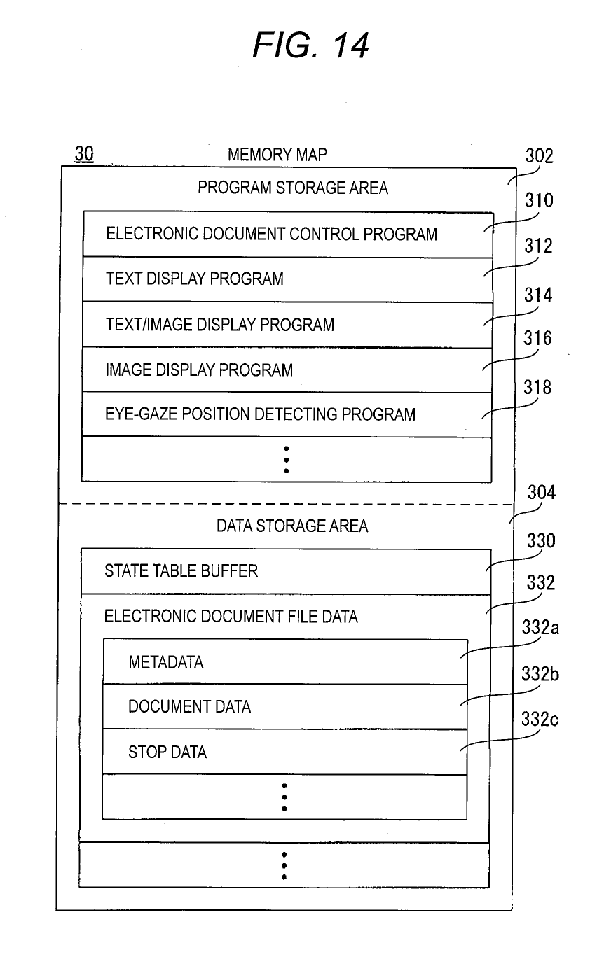

FIG. 14 is a view illustrating a memory map of the RAM 30. The RAM 30 includes a program storage area 302 and a data storage area 304. Some of programs and data are read from the flash memory 28 all at once, or partially and sequentially in some cases, and are stored in the RAM 30.

The program storage area 302 stores programs for operating the electronic document terminal 10. For example, the programs for operating the electronic document terminal 10 include an electronic document control program 310, a text display program 312, a text/image display program 314, an image display program 316, and an eye-gaze position detecting program 318, and the like.

The electronic document control program 310 is a program to be performed for browsing electronic documents. The text display program 312 is a program for performing the predetermined process based on the eye-gaze position EP detected in an electronic document, such as a contract or a novel, having the type ‘TEXT’. Similarly, the text/image display program 314 is a program for performing the predetermined process in an electronic document, such as a comic, having the type ‘TEXT/IMAGE’. The image display program 316 is a program for performing the predetermined process in an electronic document, such as a picture book, having the type ‘IMAGE’. The eye-gaze position detecting program 318 is a program for detecting the eye-gaze position EP of the user, calculating the eye-gaze speed ES and the staying time ET, and updating the state table.

Although not shown in FIG. 14, the programs for operating the electronic document terminal 10 further includes a program corresponding to basic software (operating software: OS) of the electronic document terminal, and the like.

The data storage area 304 stores a state table butter 330, electronic document file data 332, and the like. The state table butter 330 temporarily stores the state table shown in FIG. 10.

When an electronic document is browsed, the electronic document file data 332 is read from the flash memory 28 and is temporarily stored in the RAM 30. The electronic document file data 332 includes metadata 332a, document data 332b, stop data 332c, and the like. The metadata 332a has, for example, the configuration shown in FIG. 7B. The document data 332b is read when the electronic document is displayed, and includes text data and image data. The stop data 332c is generated and stored in response to stopping of the browsing before the electronic document is read up to the final page. Therefore, when browsing has not been stopped, the electronic document file data 332 does not include the stop data 332c.

Although not shown, the data storage area 304 stores image data to be displayed in a standby state, letter string data, and the like, and includes a counter or flags necessary for the operation of the electronic document terminal 10.

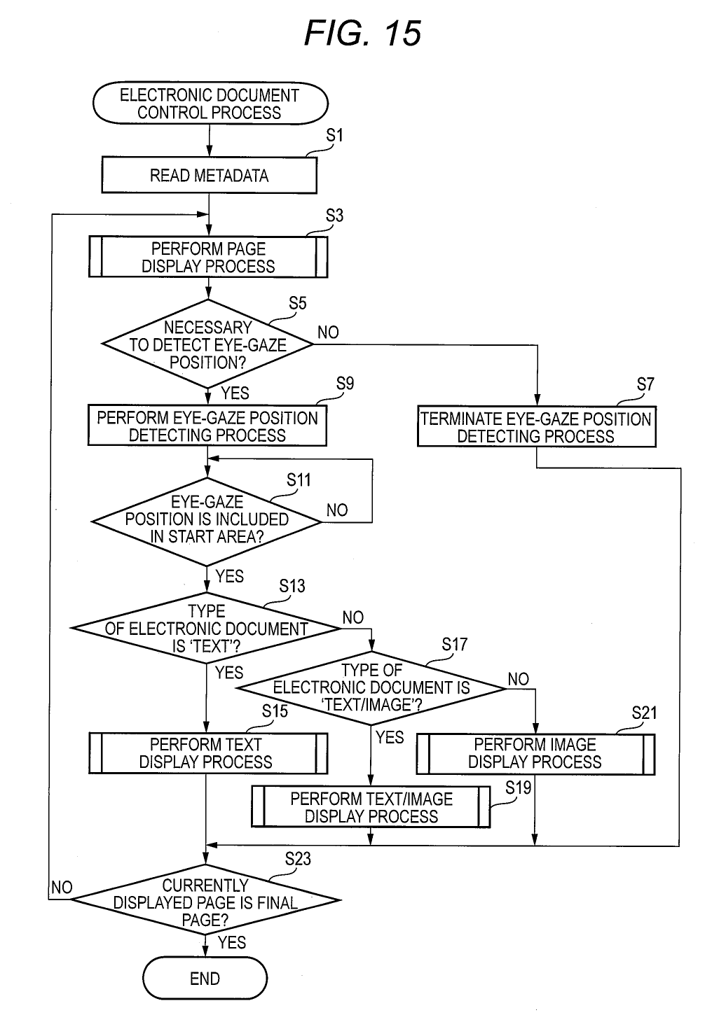

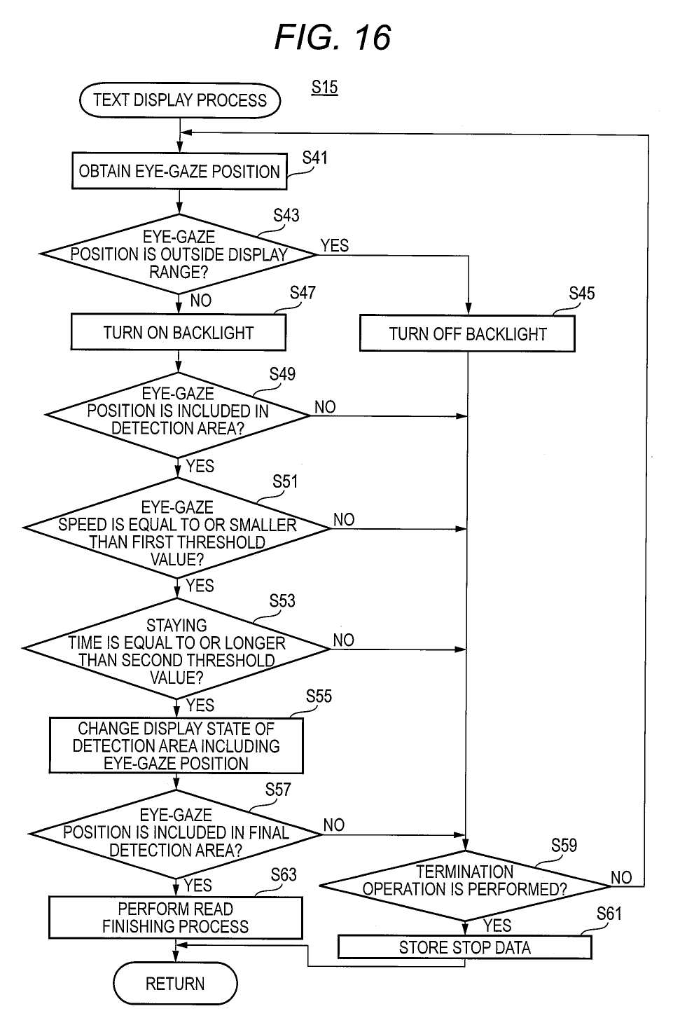

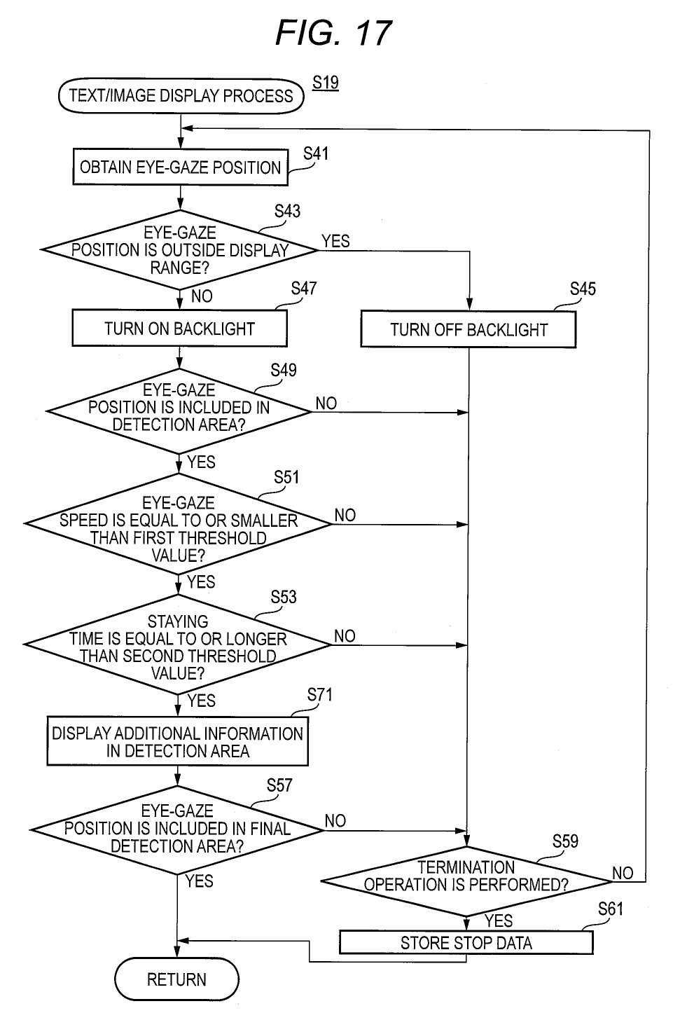

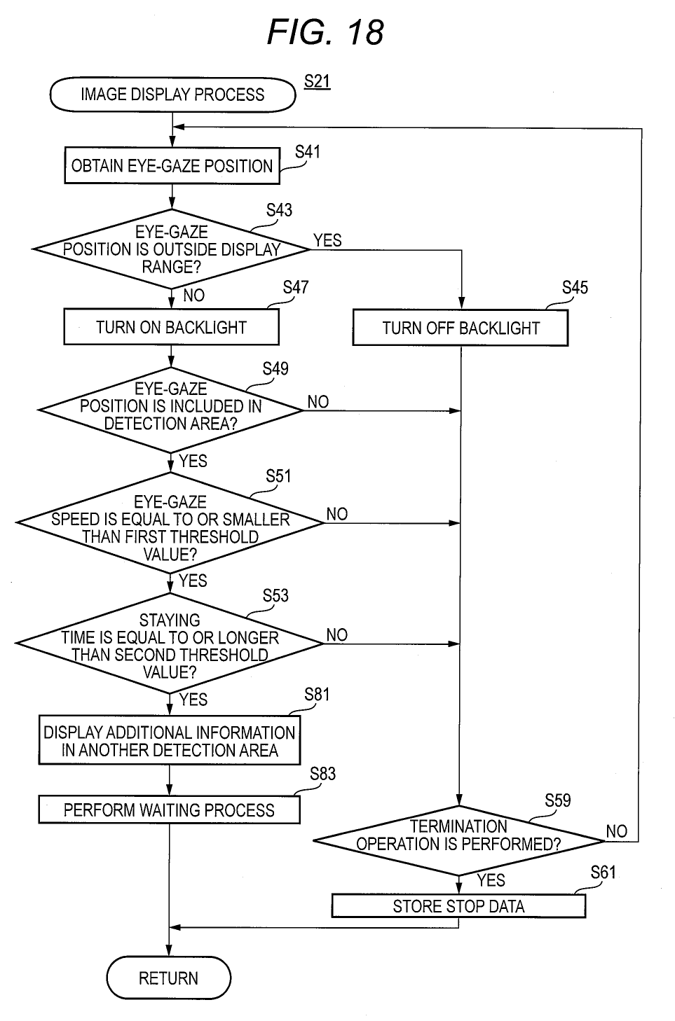

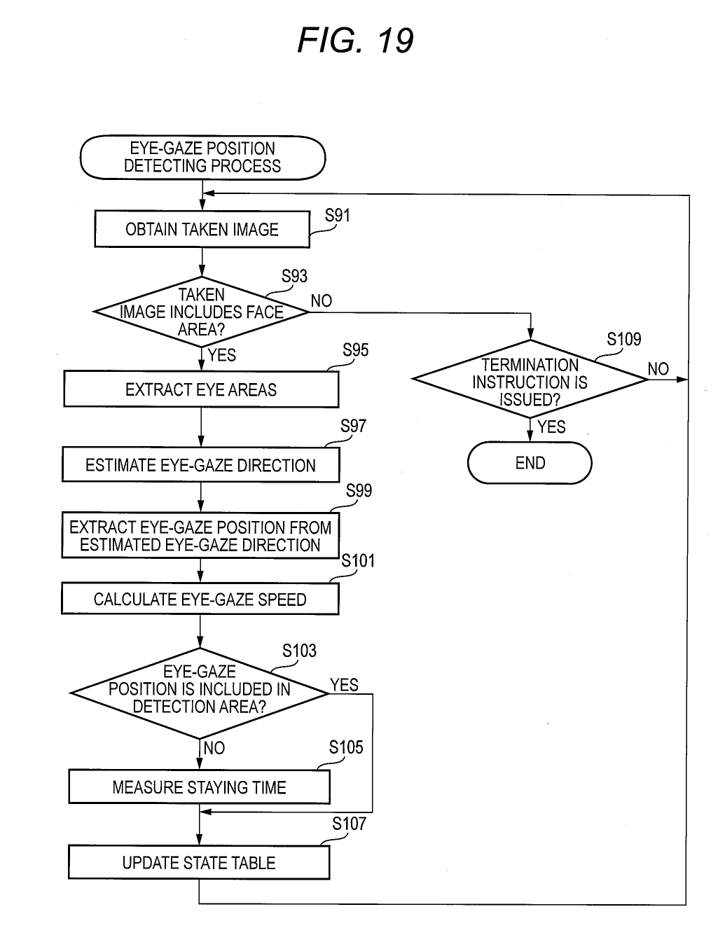

Under the control of an OS based on Linux (registered as a trademark) or other OSs, the processor 20 processes a plurality of tasks in parallel. The plurality of tasks includes an electronic document control process shown in FIG. 15, a text display process shown in FIG. 16, a text/image display process shown in FIG. 17, an image display process shown in FIG. 18, and an eye-gaze position detecting process shown in FIG. 19.

For example, if operation for browsing the electronic document is performed, in step S1, the processor 20 reads the metadata 332a of the electronic document. That is, the processor 20 reads the metadata 332a, thereby obtaining the type of the electronic document, the coordinate ranges of the detection areas DA, the first threshold value, the second threshold value, the order, the start area, and the like. Subsequently, in step S3, a page display process is performed. That is, the first page of the electronic document is displayed on the display 26. However, when the electronic document file data 332 includes the stop data 332c, the page recorded in the stop data 332c is displayed on the display 26. Also, when a determination result of step S23 (to be described below) is ‘NO’ and thus the process of step S3 is performed, the next page is displayed on the display 26. Therefore, the processor 20 performing the process of step S3 serves as a next-page display unit or performing unit.

Subsequently, in step S5, it is determined whether it is necessary to detect the eye-gaze position. For example, whether it is necessary to detect the eye-gaze position is determined based on whether the read metadata 332a includes the first threshold value or the second threshold value. If the determination result of step S5 is ‘NO’, for example, if the metadata 332a does not include the first threshold value or the second threshold value, since it is unnecessary to detect the eye-gaze position, in step S7, the processor 20 terminates the eye-gaze position detecting process, and proceeds to step S23. In other words, in step S7, the processor 20 issues an instruction to terminate the eye-gaze position detecting process shown in FIG. 19. However, if the eye-gaze position detecting process is not being been performed, the issued termination instruction is invalidated.

Meanwhile, if the determination result of step S5 is ‘YES’, for example, if the metadata 332a includes any one threshold value, in step S9, the processor 20 performs the eye-gaze position detecting process. In other words, in step S9, the processor 20 issues an instruction to perform the eye-gaze position detecting process. Subsequently, in step S11, it is determined whether the eye-gaze position EP is included in the start area. In other words, the processor 20 determines whether the eye-gaze position EP in the state table is included in the coordinate range of the start area included in the metadata 332a. If the determination result of step S11 is ‘NO’, for example, if the coordinates of the eye-gaze position EP are not included in the coordinate range of the start area, the process of step S11 is repeated.

Meanwhile, the determination result of step S11 is ‘YES’, for example, if the coordinates (Ex, Ey) of the eye-gaze position EP in the state table shown in FIG. 10 are included in the coordinate range ((X1, Y1) to (X2, Y2)) of the detection area DAa which is the start area shown in FIG. 7B, in step S13, it is determined whether the type of the electronic document is ‘TEXT’. That is, the processor 20 determines whether the type included in the metadata 332a is ‘TEXT’. If the determination result of step S13 is ‘YES’, that is, if the type of the electronic document is ‘TEXT’, the processor 20 performs the text display process in step S15, and proceeds to step S23. Meanwhile, if the determination result of step S13 is ‘NO’, that is, if the type of the electronic document is not ‘TEXT’, in step S17, it is determined whether the type of the electronic document is ‘TEXT/IMAGE’. If the determination result of step S17 is ‘YES’, that is, if the type of the electronic document is ‘TEXT/IMAGE’, the processor 20 performs the text/image display process in step S19, and proceeds to step S23. Meanwhile, if the determination result of step S17 is ‘NO’, that is, if the type of the electronic document is not ‘TEXT/IMAGE’, since the type is ‘IMAGE’, the processor 20 performs the image display process in step S21, and proceeds to step S23.

Since the text display process of step S15, the text/image display process of step S19, and the image display process of step S21 will be described with reference to FIGS. 16 to 18, they are not described here in detail.

In step S23, it is determined whether the currently displayed page is the final page. That is, it is determined whether the number of currently displayed page is the number of final page. If the determination result of step S23 is ‘NO’, that is, if the number of current page is not the number of final page, the processes returns to step S3. Meanwhile, if the determination result of step S23 is ‘YES’, that is, if the number of current page is the number of final page, the electronic document control process ends.

FIG. 16 is a flow chart illustrating the text display process. If step S15 of the electronic document control process shown in FIG. 15 is performed, in step S41, the processor 20 obtains the eye-gaze position EP. In other words, the processor 20 reads the coordinates of the eye-gaze position EP from the state table. Subsequently, in step S43, the processor 20 determines whether the eye-gaze position EP is outside the display range. In other words, the processor 20 determines whether the user is watching the display 26. If the determination result of step S43 is ‘YES’, that is, if the detected eye-gaze position EP is outside the display 26, the backlight is turned off in step S45, and the process proceeds to step S59. For example, since the user is not watching the display 26, a power supply of the backlight is turned off, thereby reducing power consumption. Meanwhile, if the determination result of step S43 is ‘NO’, since the user is watching the display 26, in step S47, the backlight is turned on. That is, the power supply of the backlight is turned on. When the backlight has been already in an ON (OFF) state, the luminance of the backlight is not changed.

Subsequently, in step S49, it is determined whether the eye-gaze position EP is included in a detection area DA. That is, the processor 20 selects a detection area DA to which the eye gaze of the user will be directed based on the order stored in the metadata 332a, and determines whether the coordinates of the eye-gaze position EP are included in the coordinate range of the selected detection area DA. If the determination result of step S49 is ‘NO’, that is, if the coordinates of the eye-gaze position EP are not included in the coordinate range of the detection area DA selected in the above-mentioned manner, the process proceeds to step S59.

If the determination result of step S49 is ‘YES’, that is, if the coordinates of the eye-gaze position EP are included in the coordinate range of the detection area DA, in step S51, it is determined whether the eye-gaze speed ES is equal to or smaller than the first threshold value, or not. That is, it is determined whether the eye-gaze speed ESₙ stored in the state table is equal to or smaller than the first threshold value recorded in the metadata 332a, or not. If the determination result of step S51 is ‘NO’, for example, if the current eye-gaze speed ESₙ is larger than THa (mm/ms), the process proceeds to step S59.

Meanwhile, if the determination result of step S51 is ‘YES’, for example, if the current eye-gaze speed ESₙ is equal to or smaller than THa (mm/ms), in step S53, it is determined whether the staying time ET is equal to or longer than the second threshold value, or not. That is, it is determined whether the current staying time ETₙ stored in the state table is equal to or longer than the second threshold value of the metadata 332a, or not. If the determination result of step S53 is ‘NO’, for example, if the staying time ETₙ at the detection area DAa is shorter than THb (ms), the process proceeds to step S59. Meanwhile, if the determination result of step S53 is ‘YES’, for example, if the staying time ETₙ at the detection area DAa is equal to or longer than THb (ms), in step S55, the processor 20 changes the display state of the detection area DAa including the eye-gaze position EP. For example, if the process of step S55 is performed, as shown in FIG. 8B, the letters in the detection area DAa are changed to the italic font style, and decrease in size.

Subsequently, in step S57, it is determined whether the eye-gaze position EP is included in the final detection area DA. That is, it is determined whether the current eye-gaze position EP recorded in the state table is included in the coordinate range of the final detection area DA in the order recorded in the metadata 332a. If the determination result of step S57 is ‘NO’, that is, if the eye-gaze position EP is not included in the final detection area DA, in step S59, it is determined whether termination operation is performed. For example, it is determined whether the function key 22c is pressed for a long time. If the determination result of step S59 is ‘NO’, that is, if the termination operation is not performed, the process returns to step S41. Meanwhile, if the determination result of step S59 is ‘YES’, that is, if the termination operation is performed, in step S61, the processor 20 stores the stop data 332c. That is, the processor 20 stores the stop data 332c generated based on the state table, in the RAM 30. If the process of step S61 finishes, the processor 20 terminates the text display process, and returns to the electronic document control process. The processor 20 performing the process of step S59 is an example of a termination operation determining unit, and the processor 20 performing the process of step S61 is an example of a storing unit.

Meanwhile, if the determination result of step S57 is ‘YES’, for example, if the display states of all of the detection areas DA have been changed, in step S63, the processor 20 performs the read finishing process. For example, in a case where the electronic document is a contract, if the read finishing process is performed, the agreement key 70 and the disagreement key 72 are displayed to be selectable as shown in FIG. 9. In a case where the electronic document is a novel, if the read finishing process is performed, that time is stored as a reading log. After the read finishing process is performed, the processor 20 terminates the text display process, and returns to the electronic document control program.

The processor 20 performing the processes of steps S49 to S53 is an example of a determining unit. Further, the processor 20 performing the process of step S55 or S63 is an example of a performing unit. Also, the processor 20 performing the process of step S63 is an example of a key display unit.

FIG. 17 is a flow chart illustrating the text/image display process. However, in the text/image display process, the same processes as those of the text display process are denoted by the same step numbers, and will be not described in detail.

If step S19 of the electronic document control process shown in FIG. 15 is performed, in step S41, the processor 20 obtains the eye-gaze position EP. Next, in step S43, it is determined whether the eye-gaze position EP is outside the display range of the display 26. If the determination result of step S43 is ‘YES’, that is, if the eye-gaze position EP is outside the display range, the backlight is turned off in step S45, and the process proceeds to step S59. Meanwhile, if the determination result of step S43 is ‘NO’, that is, if the eye-gaze position EP is inside the display range, in step S47, the backlight is turned on.

Subsequently, in step S49, it is determined whether the eye-gaze position EP is included in a detection area (a frame of a comic) DA. If the determination result of step S49 is ‘YES’, that is, if the detected eye-gaze position EP is included in a detection area DA, in step S51, it is determined whether the eye-gaze speed ES is equal to or smaller than the first threshold value, or not. If the determination result of step S51 is ‘YES’, that is, if the calculated eye-gaze speed ES is equal to or smaller than the first threshold value, in step S53, it is determined whether the staying time ET is equal to or longer than the second threshold value. If it is determined in step S51 that the calculated staying time ET is equal to or longer than the second threshold value, the processor 20 proceeds to step S71. Also, if the determination result of step S49, S51, or S53 is ‘NO’, the process proceeds to step S59.

In step S71, additional information is displayed in the detection area DA. For example, as shown in FIG. 12B, words is displayed in a balloon F in a frame (detection area DA). The processor 20 performing the process of step S71 is an example of a first additional information display unit.

Subsequently, in step S57, it is determined whether the eye-gaze position is included in the final detection area (frame) DA. If the determination result of step S57 is ‘NO’, that is, if the detection area DA determined as it has been read is not the final detection area DA, in step S59, it is determined whether the termination operation is performed. If the determination result of step S59 is ‘NO’, that is, if the termination operation is not performed, the process returns to step S41. Meanwhile, if the determination result of step S59 is ‘YES’, that is, if the termination operation is performed, the processor 20 stores the stop data in step S61, terminates the text/image display process, and returns to the electronic document control process. Also, if the determination result of step S57 is ‘YES’, that is, if the detection area DA determined as it has been read is the final detection area DA, the processor 20 terminates the text/image display process.

FIG. 18 is a flow chart illustrating the image display process. In this process, the same steps as those of the text display process are denoted by the same step numbers, and will not be described in detail.

If step S21 of the electronic document control process shown in FIG. 15 is performed, in step S41, the processor 20 obtains the eye-gaze position EP. Next, in step S43, it is determined whether the eye-gaze position EP is outside the display range of the display 26. If the determination result of step S43 is ‘YES’, that is, if the eye-gaze position EP is outside the display range, the backlight is turned off in step S45, and the process proceeds to step S59. Meanwhile, if the determination result of step S43 is ‘NO’, that is, if the eye-gaze position EP of the user is inside the display range, in step S47, the backlight is turned on.

Subsequently, in step S49, it is determined whether the eye-gaze position EP is included in a detection area DA. If the determination result of step S49 is ‘YES’, that is, if the eye-gaze position EP is included in a detection area DA, in step S51, it is determined whether the eye-gaze speed ES is equal to or smaller than the first threshold value, or not. If the determination result of step S51 is ‘YES’, that is, if the eye-gaze speed ES is equal to or smaller than the first threshold value, in step S53, it is determined whether the staying time ET is equal to or longer than the second threshold value. If the determination result of step S53 is ‘YES’, that is, if the staying time ET is equal to or loner than the second threshold value, the process proceeds to step S81.

In step S81, additional information is displayed in another detection area DA. For example, as shown in FIG. 13B, in association with the detection area DAp determined as it has been read, a picture (an image) is displayed in the detection area DAq. Subsequently, in step S83, the processor 20 performs a waiting process. That is, the processor 20 waits for a predetermined time such that the user can appreciate the additionally displayed image. If the predetermined time elapses, the processor 20 terminates the image display process, and returns to the electronic document control process. The processor 20 performing the process of step S81 is an example of a second additional information display unit.

If the determination result of step S49, S51, or S53 is ‘NO’, in step S59, it is determined whether the termination operation is performed. If the determination result of step S59 is ‘NO’, that is, if the termination operation is not performed, the process returns to step S41. Meanwhile, if the determination result of step S59 is ‘YES’, that is, if the termination operation is performed, in step S61, the processor 20 stores the stop data, and terminates the image display process.

FIG. 19 is a flow chart illustrating the eye-gaze position detecting process. For example, if an instruction to perform the eye-gaze position detecting process is issued in step S9 of the electronic document control process, in step S91, the processor 20 obtains the taken image. That is, the processor 20 reads the taken image stored in the RAM 30. Subsequently, in step S93, it is determined whether a face area is included in the taken image. That is, the processor 20 performs an image process of extracting a face area from the taken image.

If the determination result of step S93 is ‘YES’, for example, if the taken image includes a face area of the user, in step S95, the processor 20 extracts eye areas. That is, the processor 20 performs an image process of extracting areas having feature values of eyes, on the taken image. Subsequently, in step S97, the processor 20 estimates the eye-gaze direction. That is, in step S97, the processor 20 calculates the centers of iris areas based on the extracted eye areas, thereby estimating the eye-gaze direction of the user. Subsequently, in step S99, the processor 20 detects the eye-gaze position EP from the estimated eye-gaze direction. That is, the processor 20 detects the eye-gaze position EP based on the eye-gaze direction, and the eye-gaze distance between the face of the user and the display 26. The processor 20 performing the process of step S99 is an example of an eye-gaze position detecting unit.

Subsequently, in step S101, the processor 20 calculates the eye-gaze speed ES. That is, the processor 20 calculates an instant speed sₘ (mm/ms) for each frame, based on the frame time Δt (ms) and each amount of change d (mm), and calculates the average of instant speeds sₘ (mm/ms) for a predetermined time period, as the eye-gaze speed ES. The processor 20 performing the process of step S101 is an example of an eye-gaze speed calculating unit.

Subsequently, in step S103, it is determined whether the eye-gaze position EP is included in a detection area DA. For example, the processor 20 determines whether the detected eye-gaze position EP is included in any one of the detection areas DA of the displayed electronic document. If the determination result of step S103 is ‘NO’, that is, if the detected eye-gaze position EP is not included in any detection area DA, the process proceeds to step S107. Meanwhile, if the determination result of step S103 is ‘YES’, for example, if the detected eye-gaze position EPm is included in the detection area DAb as shown in FIG. 8B, in step S105, the processor 20 measures the staying time ET. Specifically, first, the processor 20 determines whether the eye-gaze position EP detected in the current process is included in the same detection area DA as that having included the eye-gaze position EP detected in the previous process. In a case where the current eye-gaze position EP is included in the same detection area DA as that having included the previous eye-gaze position EP, the processor 20 performs counting, and obtains the staying time ET based on the frame time Δt and the counted number of times. The processor 20 performing the process of step S105 is an example of a staying-time measuring unit.

In step S107, the processor 20 updates the state table. For example, the processor 20 records the detected eye-gaze position EP, the eye-gaze speed ES, and the staying time ET in the state table, as shown in FIG. 10. If the process of the step S107 finishes, the processor 20 returns to step S91.

Meanwhile, if the determination result of step S93 is ‘NO’, that is, if the taken image does not include any face area, in step S109, the processor 20 determines whether the termination instruction is issued. If the determination result of step S109 is ‘NO’, that is, if the termination instruction is not issued, the processor 20 returns to step S91. Meanwhile, if the determination result of step S109 is ‘YES’, for example, if the instruction to terminate the eye-gaze position detecting process is issued in step S7 of the electronic document control process, the processor 20 terminates the eye-gaze position detecting process.

In order to enable the user to grasp the detected eye-gaze position EP, a pointer such as an arrow may be displayed in the vicinity of the eye-gaze position EP.

Like in a comic, when the detection areas DA are surrounded by frames, the frame of the detection area DA including the eye-gaze position EP may be displayed differently from the frames of the other detection areas DA in color, line width, shape, or the like. The frame of the detection area DA including the eye-gaze position EP may be displayed in red when there is additional information, and may be displayed in black when there is no additional information.

In the metadata 332a, a plurality of detection areas DA may be set as start areas. The first threshold value and the second threshold value may be set for every page of the electronic document. In the metadata 332a, only one of the first threshold value and the second threshold value may be recorded. Also, in the metadata, the start area, the order, or the like may not be specified. That is, a method of reading an electronic document is not necessarily limited by the creator of the electronic document. Also, each detection area DA may be manually set by the creator of the electronic document, or may be automatically set by using an image recognizing process. Further, the first threshold value and the second threshold value may be set depending on the type of an electronic document.

In order to improve the accuracy of the detection of the eye-gaze position, whenever an electronic document is displayed, a correcting process (calibration) may be performed. For example, the user is asked to sequentially watch four corners of the display 26 and errors in the eye-gaze position EP at that time are corrected, it is possible improve the accuracy of the detection of the eye-gaze position EP.

In other illustrative embodiments, if the eye-gaze speed ES is larger than a preset value, the electronic document terminal may transition to a rapid reading mode. When the electronic document terminal transitions to the rapid reading mode, words such as nouns and verbs representing the contents may be highlighted by underlines or the like. And, in this mode, letters such as articles, prepositions, and pronouns connecting texts may be suppressed by, for example, decreasing those letters in size.

The electronic document terminal 10 may be configured to communicate with an external terminal or a network, such that it is possible to easily add electronic document file data.

The plurality of programs used in the present illustrative embodiment may be stored in an HDD of a server for data distribution, and be distributed to the electronic document terminal 10 through a network. Also, the plurality of programs may be stored in storage media, for example, optical discs such as CDs, DVDs, and Blu-ray discs (BD), USB memories, and memory cards, which may be sold or distributed. In a case where the plurality of programs downloaded through the above-mentioned server, a storage medium, or the like is installed in an electronic document terminal having the same configuration as that in the present illustrative embodiment, the same effects as those of the present illustrative embodiment are obtained.

The present illustrative embodiment is not limited to the electronic document terminal 10, but may be applied to so-called smart phones, personal digital assistants (PDA), desktop PCs, and notebook PCs.

What is claimed is:

1. An electronic device comprising:
a display unit configured to display an electronic document;
an image taking unit configured to take an image;
an eye-gaze position detecting unit configured to detect an eye-gaze position with respect to the display unit based on the image taken by the image taking unit;
a determining unit configured to determine whether the electronic document displayed on the display unit has been read based on the eye-gaze position detected by the eye-gaze position detecting unit; and
a performing unit configured to perform a predetermined process on the electronic document if the determining unit determines that the electronic document has been read.

2. The electronic device according to claim 1, further comprising:
an eye-gaze speed calculating unit configured to calculate an eye-gaze moving speed based on the eye-gaze position detected by the eye-gaze position detecting unit,
wherein, if the eye-gaze speed calculated by the eye-gaze speed calculating unit is equal to or smaller than a first threshold value, the determining unit determines that the electronic document displayed on the display unit has been read.

3. The electronic device according to claim 1,
wherein the electronic document includes a detection area for displaying a text or an image, the electronic device further comprising:
a staying-time measuring unit configured to measure a staying time of the eye-gaze position detected by the eye-gaze position detecting unit within the detection area,
wherein, if the staying time measured by the staying-time measuring unit is equal to or longer than a second threshold value, the determining unit determines that the electronic document displayed on the display unit has been read.

4. The electronic device according to claim 1,
wherein the electronic document includes a detection area for displaying a text or an image, the electronic device further comprising:
an eye-gaze speed calculating unit configured to calculate an eye-gaze moving speed based on the eye-gaze position detected by the eye-gaze position detecting unit; and
a staying-time measuring unit configured to measures a staying time of the eye-gaze position detected by the eye-gaze position detecting unit within the detection area,
wherein, if the eye-gaze speed calculated by the eye-gaze speed calculating unit is equal to or smaller than a first threshold value and if the staying time measured by the staying-time measuring unit is equal to longer than a second threshold value, the determining unit determines that the electronic document displayed on the display unit has been read.

5. The electronic device according to claim 1, further comprising:
a termination operation determining unit configured to determine whether a termination operation is performed; and
a storing unit configured to store stop data based on the eye-gaze position detected by the eye-gaze position detecting unit if the termination operation determining unit determines that the termination operation is performed.

6. The electronic device according to claim 1,
wherein the electronic document includes a plurality of pages, and
wherein the performing unit includes a next-page display unit configured to display a next page if the determining unit determines that one page of the electronic document has been read.

7. The electronic device according to claim 1,
wherein the performing unit includes a key display unit configured to display a key for inputting agreement or disagreement to contents of the electronic document to be operable if the determining unit determines that the electronic document has been read.

8. The electronic device according to claim 3,
wherein the performing unit includes a first additional information display unit configured to display additional information in the detection area if the determining unit determines that the detection area of the electronic document has been read.

9. The electronic device according to claim 3,
wherein the performing unit includes a second additional information display unit configured to display additional information in another detection area different from the detection area which displays an image if the determining unit determines that the detection area displaying the texts has been read.

10. A computer-readable storage medium having an electronic document control program stored thereon and readable by a processor of an electronic device which includes a display unit configured to display an electronic document and an image taking unit configured to take an image, the program, when executed by the processor, causing the processor to perform operations comprising:
detecting an eye-gaze position with respect to the display unit based on the image taken by the image taking unit;
determining whether the electronic document displayed on the display unit has been read based on the detected eye-gaze position; and
performing a predetermined process on the electronic document if it is determined that the electronic document has been read.

11. An electronic document control method for an electronic device including a display unit configured to display an electronic document and an image taking unit configured to take an image, the method comprising:
detecting an eye-gaze position with respect to the display unit based on the image taken by the image taking unit;
determining whether the electronic document displayed on the display unit has been read based on the detected eye-gaze position; and
performing a predetermined process on the electronic document if it is determined that the electronic document has been read.
